(19) United States
(12) Patent Application Publication
(10) Pub. No.: US 2011/0048341 A1
(43) Pub. Date: Mar. 3, 2011

(54) VAPOR CHAMBER AND METHOD FOR MANUFACTURING THE SAME

(75) Inventors: SHENG-CHAO ZHANG, Shenzhen City (CN); ZHI-YONG ZHOU, Shenzhen City (CN)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/632,776

(22) Filed: Dec. 7, 2009

(30) Foreign Application Priority Data
Sep. 3, 2009 (CN) 200910306547.3

(51) Int. Cl. F22B 37/18; B23P 11/00

(52) U.S. Cl. 122/366; 29/428

(57) ABSTRACT

A vapor chamber includes a container, a wick structure attached to an inner surface of the container, and a supporting structure received in the container and abutting against opposite sidewalls of the container. The supporting structure is generally in the form of a metallic sheet and comprises a plurality of supporting members extending upwardly from thereof. A through hole is defined in the supporting member from top to bottom. An opening is defined between the adjoining supporting members. Opposite ends of the supporting members abut against the wick structure located at the opposite sidewalls of the container.

### BACKGROUND

1. Technical Field

The present disclosure relates to vapor chambers and, more particularly, to a vapor chamber having stable and reliable performance and a method for manufacturing such vapor chamber.

2. Description of Related Art

Generally, vapor chambers are used to dissipate and transfer heat generated by electronic components. The vapor chamber includes a plate-shaped container, a wick structure formed on inner surfaces of the container, and working fluid sealed inside the container. The container is prone to be deformed when it is pressed or when the working fluid is vaporized, thereby adversely affecting the stable performance of the vapor chamber.

What is needed, therefore, is a vapor chamber which can overcome the limitations described, and a method for manufacturing such a vapor chamber.

### BRIEF DESCRIPTION OF THE DRAWINGS

FIG. 1 is an isometric, assembled view of a vapor chamber in accordance with a first embodiment of the present disclosure, the vapor chamber including a container.

FIG. 2 is an isometric view of a metal tube for manufacturing the container of the vapor chamber of FIG. 1.

FIG. 3 is an isometric view of the metal tube of FIG. 2 having been flattened into the container, with a wick structure arranged on inner surfaces of the metal tube.

FIG. 4 is an isometric view of a supporting structure of the vapor chamber of FIG. 1.

FIG. 5 is an isometric view similar to FIG. 1, but with a part of the container cut away.

FIG. 6 is an isometric view of a supporting structure of a vapor chamber of a second embodiment of the present disclosure.

FIG. 7 is a side view of the supporting structure of FIG. 6.

FIG. 8 is an isometric view of a supporting structure of a vapor chamber of a third embodiment of the present disclosure.

FIG. 9 is an isometric view of a supporting structure of a vapor chamber of a fourth embodiment of the present disclosure.

FIG. 10 is a side view of the supporting structure of FIG. 9.

### DETAILED DESCRIPTION

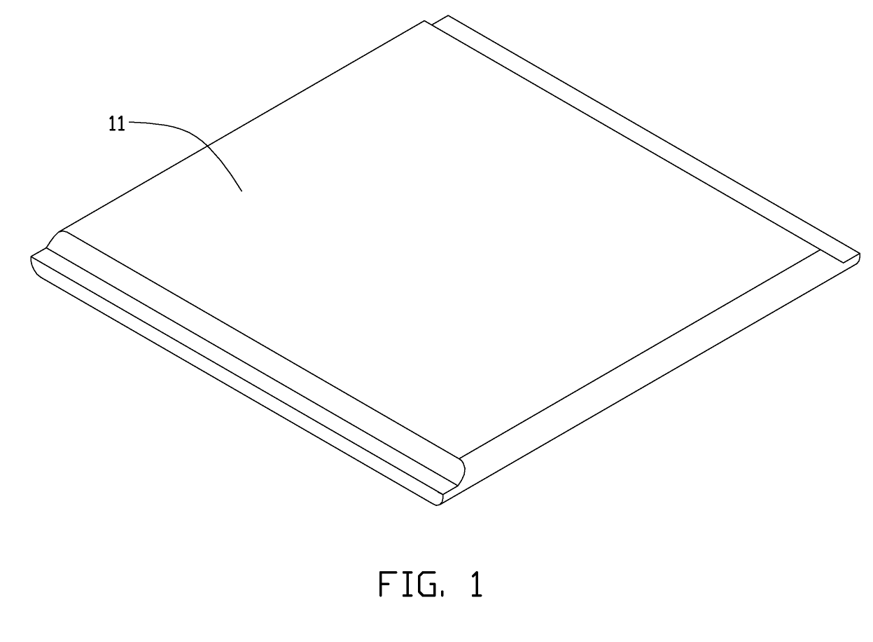

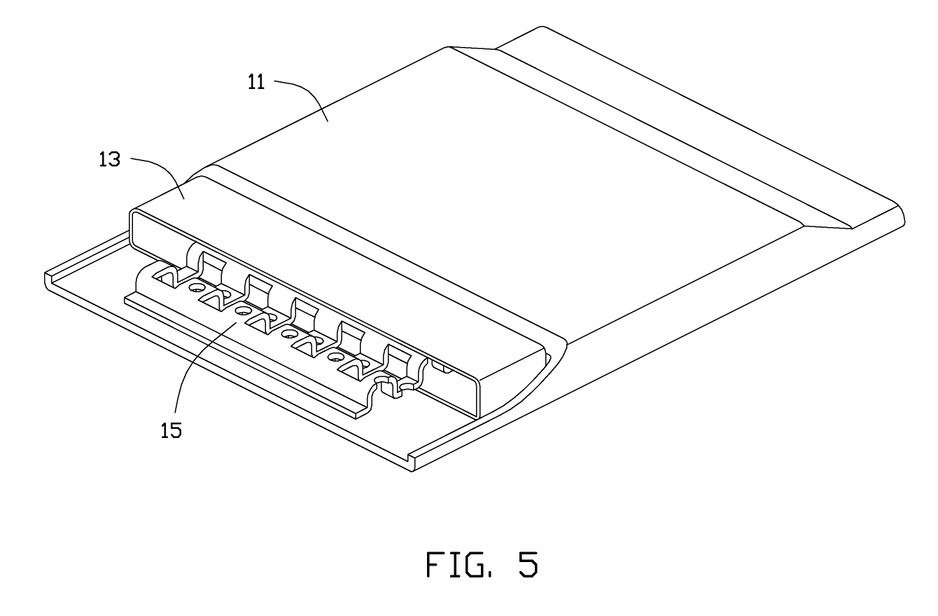

Referring to FIGS. 1-5, a vapor chamber in accordance with a first embodiment of the present disclosure comprises a container 11, a continuous wick structure 13 mounted on inner surfaces of the container 11, a supporting structure 15 received in the container 11 and abutting opposite sidewalls of the container 11, and working fluid (not shown) contained in the container 11. The container 11 is a plate-type structure, and is formed by flattening a metal tube 10. The wick structure 13 is a sintered wick layer formed from sintering metal powder.

The supporting structure 15 is formed from a flat metal sheet by punching. The supporting structure 15 comprises a number of first supporting members 151, a number of elongate second supporting members 153, a number of first connecting members 155, and a number of second connecting members 156.

The first supporting members 151 are arranged in a plurality of spaced rows, each row extending along a widthwise direction of the supporting structure 15. Each row of the first supporting members 151 comprises a plurality of inverted U-shaped first supporting portions 152 and two inverted U-shaped second supporting portions 154. The first and second supporting portions 152, 154 are aligned with each other and spaced from each other. The first supporting portions 152 of each row of the first supporting members 151 are arranged between the two second supporting portions 154 of that row. That is, the two second supporting portions 154 are located at front and rear ends of the row of first supporting members 151. Each first supporting portion 152 comprises a top plate 1521, and a first sidewall 1523 and a second sidewall 1525 extending downwardly from opposite edges of the top plate 1521. A central portion of the top plate 1521 defines a first through hole 1524 therein. A first through channel 1516 is defined and enclosed by the first and second sidewalls 1523, 1525 of all of the first supporting portions 152 in the one row, and is thereby defined as spanning between front and rear ends of the row of first supporting portions 152.

Each second supporting portion 154 comprises a top plate 1541, and a first sidewall 1543 and a second sidewall 1545 extending downwardly from opposite edges of the top plate 1541. A second through channel 1517 is defined and enclosed by the first and second sidewalls 1543, 1545, and is thereby defined as spanning between front and rear ends of the second supporting portion 154. The first and second through channels 1516, 1517 of a corresponding row of the first supporting members 151 face each other end-to-end and communicate with each other. Vaporized working fluid spreads outwardly from the first and second through channels 1516, 1517 and upwardly from the first through holes 1524 and gaps between the first and second supporting portions 152, 154. Top surfaces of the top plates 1521 of the first supporting portions 152 and top surfaces of the top plates 1541 of the second supporting portions 154 are coplanar and abut against the wick structure 13 mounted on a top end of the container 11.

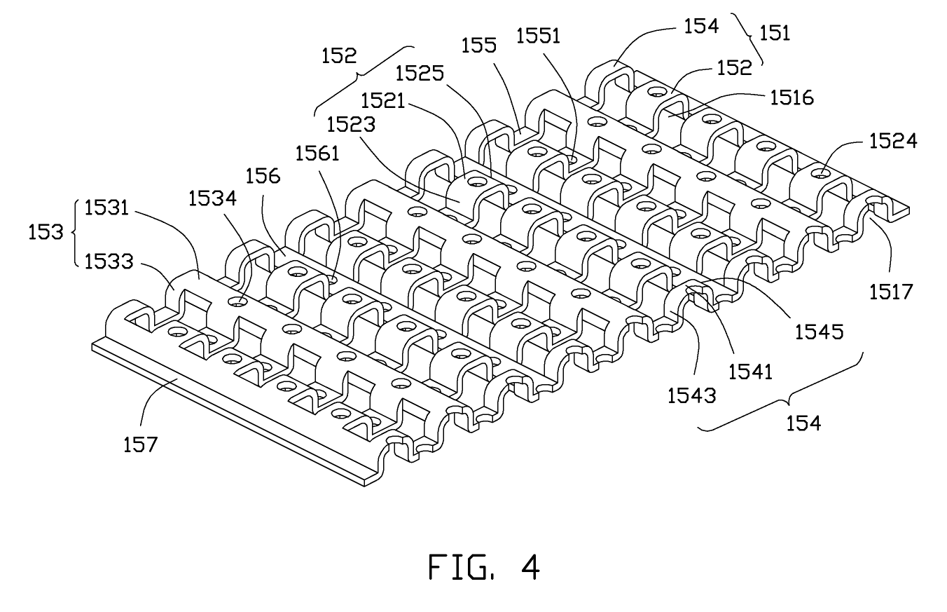

Each of the second supporting members 153 is arranged along the widthwise direction of the supporting structure 15. Each second supporting member 153 is integrally positioned between two adjoining rows of the first supporting members 151. Each second supporting member 153 comprises an elongated supporting plate 1531, and a plurality of pairs of spaced sidewalls 1533 extending perpendicularly and downwardly from opposite edges of the supporting plate 1531. The pairs of sidewalls 1533 are arranged along a lengthwise direction of the supporting plate 1531. All the sidewalls 1533 along one lateral side (the left side, as viewed in FIG. 4) of the supporting plate 1531 are aligned with the second sidewalls 1525, 1545 of the first and second supporting portions 152, 154 in the adjacent row of first and second supporting portions 152, 154. All the sidewalls 1533 along an opposite lateral side (the right side, as viewed in FIG. 4) of the supporting plate 1531 are aligned with the first sidewalls 1523, 1543 of the first and second supporting portions 152, 154 in the adjacent row of first and second supporting portions 152, 154. A central portion of the supporting plate 1531 defines a number of second through holes 1534 therein to allow the vaporized working fluid to flow therethrough. A top surface of the supporting plate 1531 and the top surfaces of the top plates 1521 of the first supporting portions 152 of the two adjacent rows of first supporting members 151 are coplanar with one another.

The first connecting members 155 are rectangular sheets. The first connecting members 155 are arranged in a plurality of rows, each row extending along the widthwise direction of the supporting structure 15. Each row of the first connecting members 155 is integrally positioned between an adjacent row of the first supporting members 151 and an adjacent second supporting member 153. The first connecting members 155 of each row of the first connecting members 155 are spaced from each other.

First edges of the row of first connecting members 155 at one side of each second supporting member 153 perpendicularly connect with bottom ends of the sidewalls 1533 of the second supporting member 153. Opposite second edges of such row of the first connecting members 155 perpendicularly connect with bottom ends of the first sidewalls 1523, 1543 of the first and second supporting portions 152, 154 of the adjacent row of first supporting members 151. First edges of the row of first connecting members 155 at an opposite side of said each second supporting member 153 perpendicularly connect with bottom ends of the sidewalls 1533 of the second supporting member 153. Opposite second edges of such row of the first connecting members 155 perpendicularly connect with bottom ends of the second sidewalls 1525, 1545 of the first and second supporting portions 152, 154 of the adjacent row of first supporting members 151.

Bottom surfaces of the first connecting members 155, the bottom ends of the first and second sidewalls 1523, 1525, 1543, 1545 of the first and second supporting portions 152, 154, and the bottom ends of the sidewalls 1533 of the second supporting member 153 are all coplanar with one another, and abut against the wick structure 13 mounted on a bottom end of the container 11. In each row of the first connecting members 155, all but two of the first connecting members 155 has a third through hole 1551 defined therein, to allow the vaporized working fluid to flow therethrough. Only the two endmost first connecting members 155 in each row of the first connecting members 155 do not have a third through hole 1551 defined therein. In the illustrated embodiment, one of such two endmost first connecting members 155 has a cutout (not labeled) defined therein, the cutout being equivalent to part of a third through hole 1551.

One second supporting member 153, two corresponding adjacent rows of first supporting members 151 and two corresponding adjacent rows of first connecting members 155 connecting the second and first supporting members 153, 151, cooperatively form a supporting section (not labeled). Each of the second connecting members 156 is an elongated sheet, and is integrally located between two adjoining rows of the first supporting members 151 of two adjoining supporting sections. Each second connecting member 156 perpendicularly connects with the bottom ends of the first and second sidewalls 1523, 1525, 1543, 1545 of the first and second supporting portions 152, 154 of the adjacent rows of first supporting members 151. Bottom surfaces of the second connecting members 156 and the bottom surfaces of the first connecting members 155 are all coplanar with one another. A plurality of fourth through holes 1561 is defined in most portions of each second connecting member 156, except two end portions thereof. In the illustrated embodiment, one of such two end portions has a cutout (not labeled) defined therein, the cutout being equivalent to part of a fourth through hole 1561.

The supporting structure 15 further comprises two elongated mounting plates 157 extending outwardly from lateral ends thereof. In the illustrated embodiment, a left-hand one of the mounting plates 157 perpendicularly connects with an adjacent row of modified first supporting members 151. The modified first supporting members 151 do not have first sidewalls 1523, 1543. Instead, a continuous plate runs along the lengthwise direction of the row of modified first supporting members 151, the continuous plate occupying a position that would otherwise be occupied by first sidewalls 1523, 1543. The left-hand mounting plate 157 perpendicularly connects with a bottom end of such continuous plate. A right-hand one of the mounting plates 157 perpendicularly connects with bottom ends of an adjacent row of the first supporting members 151. In particular, the right-hand mounting plate 157 perpendicularly connects with the bottom ends of the second sidewalls 1525, 1545 of the adjacent row of first supporting members 151. Bottom surfaces of both the mounting plates 157 are coplanar with the bottom surfaces of the first connecting members 155.

When a bottom end of the vapor chamber thermally contacts one or more electronic components (not shown), the working fluid absorbs heat and is vaporized. The vaporized working fluid spreads outwardly from the first and second through channels 1516, 1517; and spreads upwardly from the first, second, third and fourth through holes 1524, 1534, 1551, 1561, from the gaps between the first and second supporting portions 152, 154, and from gaps between the first connecting members 155 of the supporting structure 15. When the vaporized working fluid arrives at a top end of the vapor chamber, heat of the vaporized working fluid is absorbed by the top end of the container 11. Thus, the working fluid is condensed and flows back to the bottom end of the vapor chamber via the wick structure 13.

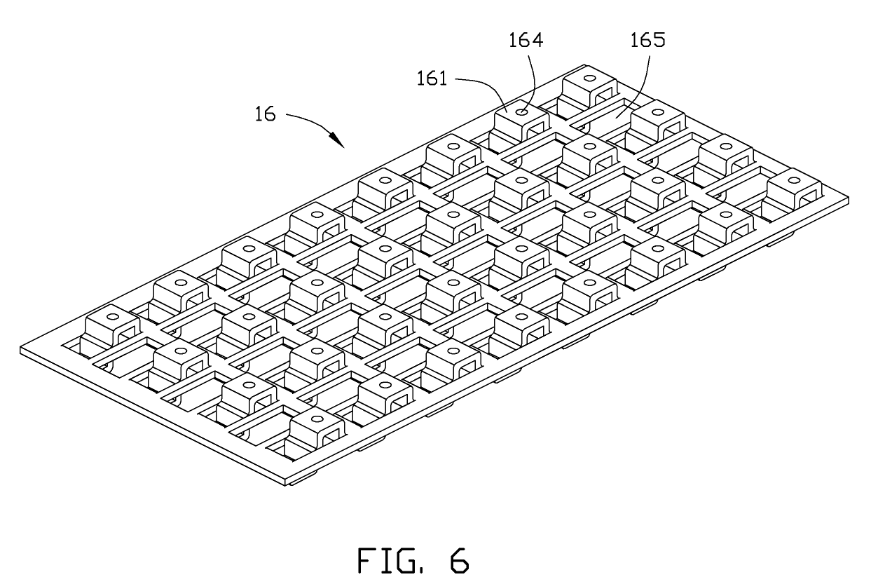

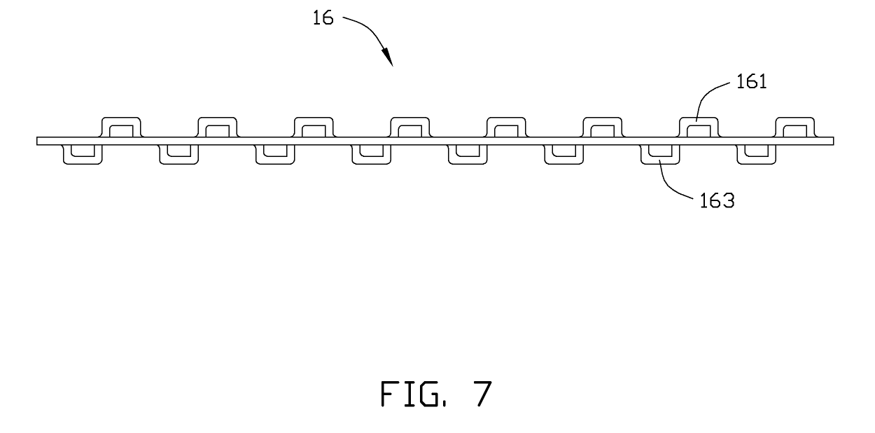

Referring to FIGS. 6-7, these illustrate a supporting structure 16 of a vapor chamber of a second embodiment of the present disclosure. The supporting structure 16 is generally in the form of a rectangular metal sheet, and comprises a number of first supporting members 161 and second supporting members 163. The first supporting members 161 protrude upwardly and are located at a top side of the supporting structure 16. The second supporting members 163 protrude downwardly and are located at a bottom side of the supporting structure 16. Each of the first supporting members 161 has an inverted U-shaped configuration, and each of the second supporting members 163 has a U-shaped configuration.

The first and second supporting members 161, 163 are arranged in a number of rows along a widthwise direction of the supporting structure 16, respectively. The rows of first supporting members 161 and the rows of second supporting members 163 are alternately arranged side by side. Left bottom ends of the first supporting members 161 of one row connect with right top ends of the second supporting members 163 of a corresponding adjacent row. Right bottom ends of the first supporting members 161 of one row connect with left top ends of the second supporting members 163 of a corresponding adjacent row. Each pair of first and second supporting members 161, 163 connected to each other forms an S-shaped supporting section (not labeled). The supporting sections are arranged in a plurality of rows along the widthwise direction of the supporting structure 16. A rectangular opening 165 is defined between each two adjacent supporting sections in each row of the supporting sections. Each two adjacent rows of the supporting sections are spaced from each other by a beam (not labeled). Each of the first and second supporting members 161, 163 defines a through hole 164 at a central portion thereof, to allow vaporized working fluid to flow therethrough.

Considered another way, the first and second supporting members 161, 163 are alternately interconnected with each other in lines, each line running along a lengthwise direction of the supporting structure 16. The lines of first and second supporting members 161, 163 are spaced apart from each other, by reason of the provision of the rectangular openings 165. In particular, each of lines of rectangular openings 165 essentially separates two adjacent lines of first and second supporting members 161, 163.

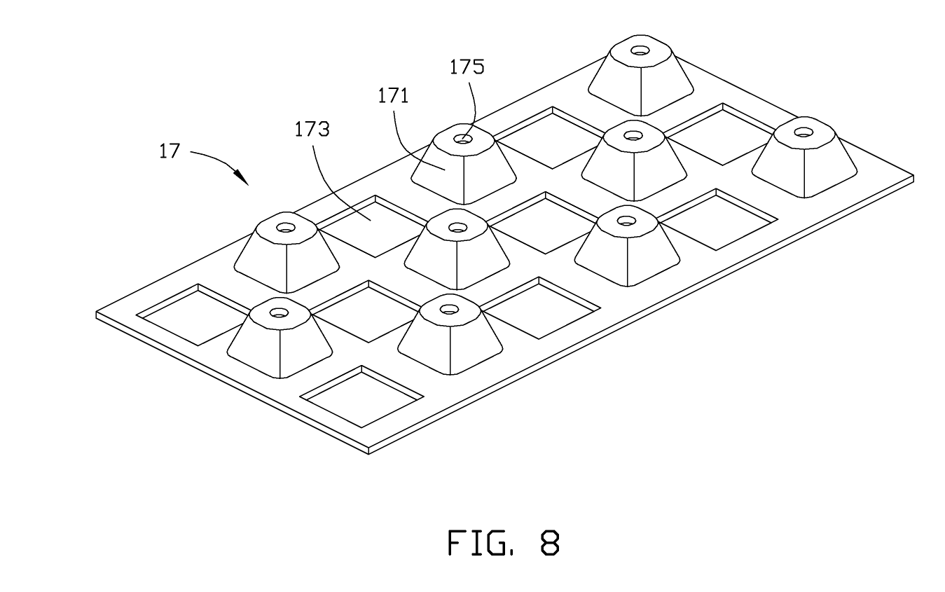

Referring to FIG. 8, this illustrates a supporting structure 17 of a vapor chamber of a third embodiment of the present disclosure. The supporting structure 17 is generally in the form of a rectangular metal sheet, and comprises a number of supporting members 171. Each of the supporting members 171 is generally in the form of a hollow truncated pyramid. Considered another way, each supporting member 171 has a generally frusto-conical shape. In particular, each supporting member 171 has a square base, and a flat, round top. The supporting members 171 extend upwardly from a top surface of the supporting structure 17 and are arranged in a plurality of rows along a lengthwise direction of the supporting structure 17. An opening 173 is defined between two adjoining supporting members 171 along the lengthwise direction of the supporting structure 17 and along a widthwise direction of the supporting structure 17. That is, the supporting members 171 and openings 173 are arranged across the supporting structure 17 like a checkerboard. A through hole 175 is defined at a central portion of each supporting member 171, to allow vaporized working fluid to flowing therethrough.

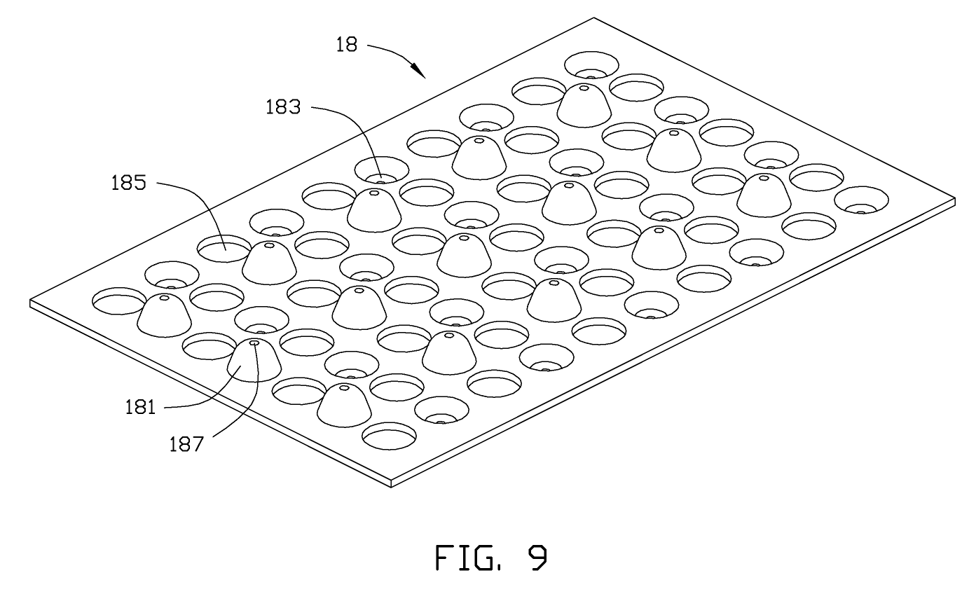

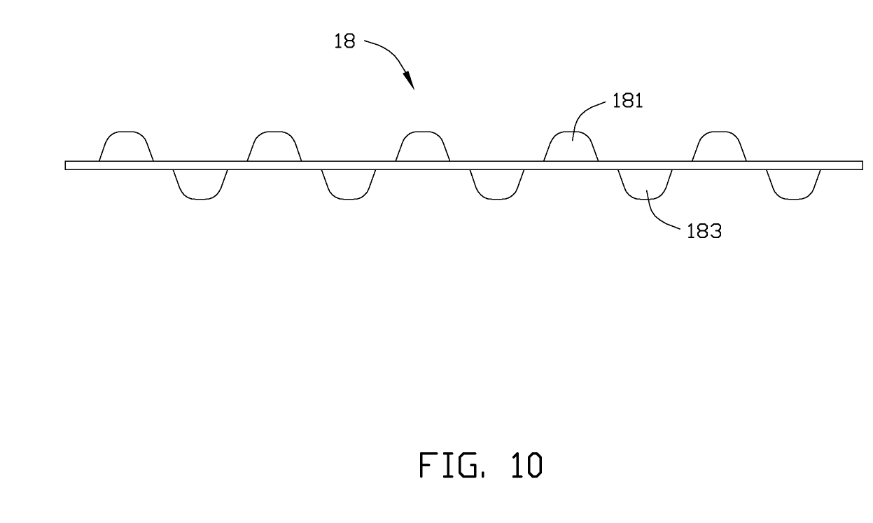

Referring to FIGS. 9-10, these illustrate a supporting structure 18 of a vapor chamber of a fourth embodiment of the present disclosure. The supporting structure 18 is generally in the form of a rectangular metal sheet, and comprises a number of first supporting members 181 and a number of second supporting members 183. The first and second supporting members 181, 183 are generally in the form of hollow tapered dome-shaped protrusions. The first supporting members 181 extend upwardly and are located at a top side of the supporting structure 18. The second supporting members 183 extend downwardly and are located at a bottom side of the supporting structure 18. The first supporting members 181 are arranged in a number of rows along a widthwise direction of the supporting structure 18, and the second supporting members 183 are also arranged in a number of rows along the widthwise direction of the supporting structure 18. The rows of first supporting members 181 and the rows of second supporting members 183 are alternately arranged side by side.

In each row of first supporting members 181, a through hole 185 is defined between each two adjacent first supporting members 181. In each row of second supporting members 183, a through hole 185 is defined between each two adjacent second supporting members 183. One through hole 185 is located between each two adjacent first supporting members 181 along a lengthwise direction of the supporting structure 18. One through hole 185 is located between each two adjacent second supporting members 183 along the lengthwise direction of the supporting structure 18. Thus, the first supporting members 181, the second supporting members 183 and the through holes 185 are arranged like a checkerboard across the supporting structure 18. In particular, the first supporting members 181 together with the second supporting members 183 can be considered to occupy positions corresponding to one color of a checkerboard, and the through holes 185 can be considered to occupy positions corresponding to the other color of a checkerboard. Each of the first and second supporting members 181, 183 defines a through hole 187 at a central portion thereof.

An exemplary method for manufacturing a vapor chamber includes steps as follows:

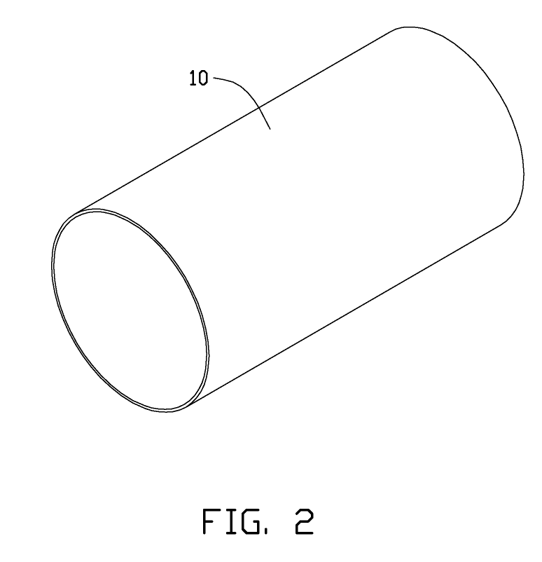

Firstly, as shown in FIG. 2, a metal tube 10 is provided. The metal tube 10 has a predetermined length, and is made of a material with good thermal conductivity such as copper.

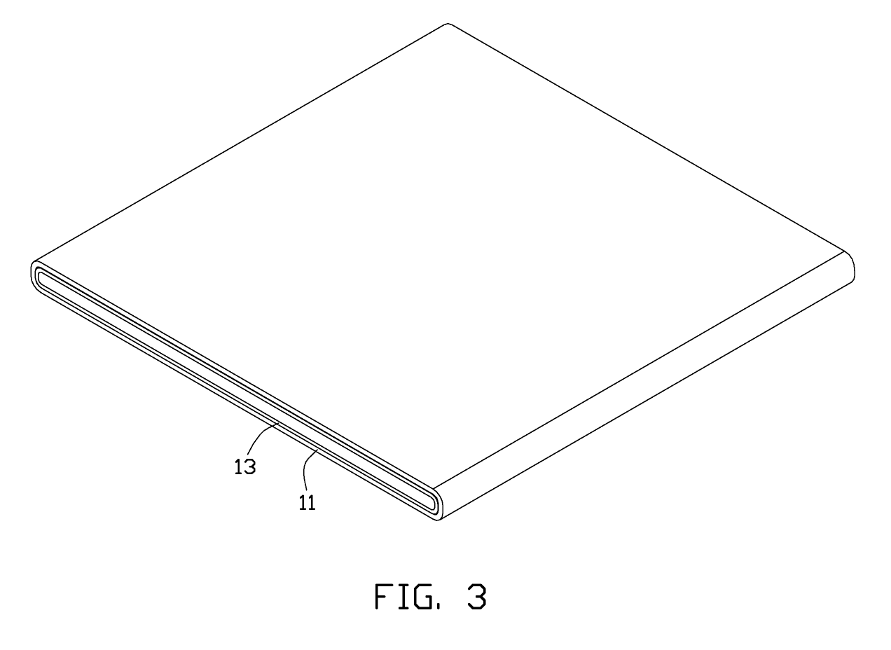

Secondly, as shown in FIG. 3, the metal tube 10 is flattened into a rectangular plate-shape container 11, and thus has two elongated openings at two opposite ends thereof.

Thirdly, an insert (not shown) is provided and inserted into the container 11. The insert has a configuration similar to that of the container 11, but has a slightly smaller size than the container 11. Metal powder is filled between the inner surfaces of the container 11 and an outer surface of the insert. Then the metal powder is sintered on the inner surfaces of the container 11 by heat treating the container 11, to form the wick structure 13 over the inner surfaces of the container 11.

Fourthly, a supporting member such as one of the supporting members 15, 16, 17, 18 is provided and inserted into the container 11. The two opposite outer flat surfaces of the container 11 are pressed to make the top and bottom surfaces of the supporting member 15, 16, 17, or 18 engage with the wick structure 13 formed on the inner surfaces of the container 11.

Finally, the openings of the container 11 are sealed, the container 11 is evacuated, and working fluid is filled in the container 11.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A vapor chamber comprising:
a container;
a wick structure formed on an inner surface of the container; and
a supporting structure received in the container and abutting against the wick structure at opposite lateral sidewalls of the container;
wherein the supporting structure is generally in the form of a metallic sheet, and comprises a plurality of supporting members extending upwardly therefrom, each of the supporting members has a through hole defined therein, the supporting structure defines an opening between each two adjacent supporting members, and opposite ends of each of the supporting members abut against the wick structure located at opposite top and bottom sidewalls of the container.

2. The vapor chamber as claimed in claim 1, wherein the supporting members comprises two rows of first supporting portions and a second supporting portion between the two rows of first supporting portions, the first supporting portions of each of the rows are spaced from each other, and each row of the first supporting portions defines a through channel spanning from a front end of the row to a rear end of the row.

3. The vapor chamber as claimed in claim 2, wherein the second supporting portion comprises an elongated supporting plate and a plurality of pairs of spaced sidewalls extending downwardly from opposite long edges of the supporting plate, and at least a central portion of the supporting plate has a plurality of the through holes defined therein.

4. The vapor chamber as claimed in claim 3, wherein a top surface of the supporting plate of the second supporting portion and top ends of the first supporting portions are all substantially coplanar with one another.

5. The vapor chamber as claimed in claim 3, wherein each of the first supporting portions comprises a top plate, and a first sidewall and a second sidewall extending downwardly from opposite edges of the top plate, a row of first connecting members is provided between each row of the first supporting portions and the second supporting portion, and opposite edges of the first connecting members in each row of the first connecting members connect with bottom ends of the corresponding first or second sidewalls of the first supporting portions and with an adjacent sidewall of the second supporting portion, respectively.

6. The vapor chamber as claimed in claim 5, wherein each of the first connecting members has a through hole defined therein.

7. The vapor chamber as claimed in claim 6, wherein the supporting members comprises three rows of the first supporting portions, the second supporting portion is between a first one of the rows of first supporting portions and a second one of the rows of first supporting portions, a third one of the rows of first supporting portions is generally adjacent to the second row of first supporting portions, a second connecting member is provided between the second and third rows of the first supporting portions, and the second connecting member connects with the bottom ends of the corresponding first or second sidewalls of the first supporting portions in the second row of the first supporting portions and with the bottom ends of the corresponding second or first sidewalls of the first supporting portions in the third row of the first supporting portions.

8. The vapor chamber as claimed in claim 7, wherein the a second connecting member is elongated and defines a plurality of through holes therein.

9. The vapor chamber as claimed in claim 1, wherein two elongated mounting plates extend outwardly from lateral ends of the supporting structure and abut against the wick structure at the bottom sidewall of the container.

10. The vapor chamber as claimed in claim 1, wherein the supporting structure further comprises a plurality of other supporting members extending downwardly therefrom to abut against the wick structure at the bottom sidewall of the container.

11. The vapor chamber as claimed in claim 10, wherein the supporting members and the other supporting members are arranged in a plurality of rows along a widthwise direction of the supporting structure, and the rows of the supporting members and the rows of the other supporting members are alternately arranged side by side.

12. The vapor chamber as claimed in claim 11, wherein each of the supporting members and each of the other supporting members has a U-shaped configuration, left bottom ends of the supporting members of one row of the supporting members connect with right top ends of the other supporting members of a corresponding adjacent row of the other supporting members, and right bottom ends of the supporting members of one row of the supporting members connect with left top ends of the other supporting members of a corresponding adjacent row of the other supporting members.

13. The vapor chamber as claimed in claim 12, wherein each of the supporting members and a corresponding adjoining other supporting member form an S-shaped supporting section.

14. The vapor chamber as claimed in claim 13, wherein each of the openings is defined between two corresponding adjacent supporting sections in each row of the supporting sections, and each of the other supporting members has a through hole defined therein.

15. The vapor chamber as claimed in claim 1, wherein each of the supporting members is generally in the form of a hollow truncated pyramid.

16. The vapor chamber as claimed in claim 15, wherein each of the openings has at least one of the following locations: between two corresponding adjacent supporting members along a lengthwise direction of the supporting structure, and between two corresponding adjacent supporting members along a widthwise direction of the supporting structure.

17. The vapor chamber as claimed in claim 11, wherein the supporting members and the other supporting members are generally in the form of hollow tapered dome-shaped protrusions, each of the openings is defined between two corresponding adjacent supporting members in one of the rows of the supporting members, the supporting structure further comprises a plurality of other openings, and each of the other openings is defined between two corresponding adjacent other supporting members in one of the rows of the other supporting members.

18. A method for manufacturing a vapor chamber, the method comprising:
providing a flattened container having at least an opening in an end thereof;
forming a wick structure on an inner surface of the container;
providing a supporting structure;
placing the supporting structure into the container such that the supporting structure abuts against the wick structure at opposite lateral sidewalls of the container; and
filling the container with working liquid and sealing the container;
wherein the supporting structure is generally in the form of a metallic sheet and comprises a plurality of supporting members extending upwardly therefrom, each of the supporting members has a through hole defined therein, the supporting structure defines an opening between each two adjacent supporting members, and opposite ends of the supporting members abut against the wick structure located at opposite top and bottom sidewalls of the container.
